(19) United States
(12) Patent Application Publication
(10) Pub. No.: US 2026/0038914 A1
(43) Pub. Date: Feb. 5, 2026

(54) BATTERY MODULE AND BATTERY MODULE DESIGN SYSTEM

(71) Applicant: SAMSUNG SDI CO., LTD., Yongin-si (KR)

(72) Inventors: Dong Hyeong KIM, Suwon-si (KR); Du Seong JEON, Suwon-si (KR); Jeong Ho KIM, Suwon-si (KR)

(21) Appl. No.: 19/269,391

(22) Filed: Jul. 15, 2025

(30) Foreign Application Priority Data
Jul. 30, 2024 (KR) 10-2024-0100781

(51) Int. Cl. H01M 10/658; H01M 50/204; H01M 50/231; H01M 50/233; H01M 50/249; H01M 50/342

(52) U.S. Cl. CPC H01M 10/658; H01M 50/231; H01M 50/233; H01M 50/249; H01M 50/3425; H01M 50/204

(57) ABSTRACT

A battery module includes a plurality of battery cells, a housing accommodating the plurality of battery cells, and a protective layer on an inner surface of the housing to face the plurality of battery cells, the protective layer including a thermal insulation material. In an example, each of the plurality of battery cells may include an electrode assembly, a case accommodating the electrode assembly, and a cap plate including a vent, the cap plate being coupled to an opening of the case, wherein the protective layer faces the vent.

### CROSS-REFERENCE TO RELATED APPLICATION

The present application claims priority and the benefit of Korean Patent Application No. 10-2024-0100781, filed on Jul. 30, 2024 in the Korean Intellectual Property Office, the entire disclosure of which is incorporated herein by reference.

### BACKGROUND

### 1. Field

The present disclosure relates to a battery module and a battery module design system.

### 2. Description of the Related Art

Secondary batteries are batteries that can be charged and discharged, unlike primary batteries that cannot be recharged. Low-capacity batteries are used in small portable electronic devices such as smartphones, feature phones, notebook computers, digital cameras, and camcorders, while large-capacity batteries are widely used as power sources for driving motors in hybrid vehicles, electric vehicles, and as power storage batteries. These batteries include an electrode including a positive electrode and/or a negative electrode, an electrode assembly including the electrode, a case accommodating the electrode assembly, an electrode terminal connected to the electrode assembly, and the like.

As technology advances, higher capacity batteries are required. Accordingly, a plurality of batteries can be electrically connected and used. For example, the battery may be applied to electronic devices in the form of a battery module including a plurality of batteries, and/or a battery pack including a plurality of battery modules. At this time, electronic devices include electronic devices that require high output and/or high capacity, such as electric vehicles.

As electronic devices require high output and/or high capacity, batteries inserted into electronic devices are also required to have high output and/or high capacity. Accordingly, the batteries are applied to electronic devices in the form of a battery module including a plurality of battery cells, and/or a battery pack including a plurality of battery modules.

Meanwhile, a battery module includes, for example, a plurality of battery cells and a housing including the plurality of battery cells. Battery cells repeatedly expand and contract during the process of repeated charging and discharging. Alternatively, battery cells may expand over time as the electrode plates deteriorate. Alternatively, the battery cells may react physically and/or chemically with the internal and external components. In this case, the battery cells may generate gas internally and/or the generated gas may accumulate internally.

Battery cells can explode and eject gases to the outside as the amount of gas accumulated inside increases. In this case, the battery module including the battery cells emits strong gas to the outside as the case is broken.

The above-described information disclosed in the background technology of this disclosure is only intended to improve understanding of the background of the present disclosure and therefore may include information that does not constitute the related art.

### SUMMARY

Embodiments include a battery module, including a plurality of battery cells, a housing accommodating the plurality of battery cells, and a protective layer on an inner surface of the housing to face the plurality of battery cells, the protective layer including a thermal insulation material.

Each of the plurality of battery cells may include an electrode assembly, a case accommodating the electrode assembly, and a cap plate including a vent, the cap plate being coupled to an opening of the case, wherein the protective layer faces the vent.

The protective layer of each of the plurality of battery cells may be perpendicular to the vent in a height direction.

The protective layer of each of the plurality of battery cells may have an area of 50% or more of an area of the vent when viewed from above the vent.

The cap plate may be at a lower portion of the case, and the protective layer may be on lower portions of the plurality of battery cells.

The cap plate may be at an upper portion of the case, and the protective layer may be above upper portions of the plurality of battery cells.

The protective layer may have a thickness and thermal conductivity satisfying Mathematical Formula 1:

$$\frac{1500 - \frac{Tm}{2}}{\frac{1}{h \cdot 0.001 \cdot 2} + \frac{{t}_{i}}{k \cdot 0.001 \cdot 2}} < 0.001 \cdot 2 \cdot \frac{1}{30} \cdot Cp \cdot ρ \cdot {t}_{h} \cdot Tm$$

wherein Tm represents a melting point of the housing, h represents a convective heat transfer coefficient, tᵢ represents a thickness of the protective layer, k represents a thermal conductivity of the protective layer, Cp represents a specific heat of the housing, ρ represents a density of the housing, and tₕ represents a thickness of the housing.

The protective layer may have a thickness of 3 mm or less.

The protective layer may have a heat-resistant temperature of 300° C. or higher.

The protective layer may be at a distance of 30 mm or less from the plurality of battery cells.

Embodiments include a battery module design system, including a processor for designing a battery module, wherein the processor is configured to design the battery module to include a plurality of battery cells, a housing in which the plurality of battery cells are accommodated and a protective layer positioned between the housing and at least one of the plurality of battery cells and including a thermal insulation material, and wherein the processor is further configured to design the protective layer.

Each of the plurality of battery cells may include an electrode assembly, a case accommodating the electrode assembly, and a cap plate including a vent, the cap plate being coupled to an opening of the case, wherein the processor may be configured to design the protective layer to face the vent.

The processor may be configured to design the protective layer to have a thickness and thermal conductivity satisfying Mathematical Formula 1:

$$\frac{1500 - \frac{Tm}{2}}{\frac{1}{h \cdot 0.001 \cdot 2} + \frac{{t}_{i}}{k \cdot 0.001 \cdot 2}} < 0.001 \cdot 2 \cdot \frac{1}{30} \cdot Cp \cdot ρ \cdot {t}_{h} \cdot Tm$$

wherein Tm represents a melting point of the housing, h represents a convective heat transfer coefficient, tᵢ represents a thickness of the protective layer, k represents a thermal conductivity of the protective layer, Cp represents a specific heat of the housing, ρ represents a density of the housing, and tₕ represents a thickness of the housing.

The processor may be configured to design the protective layer to have a thickness of 3 mm or less while satisfying Mathematical Formula 1.

The processor may be configured to design the protective layer with a heat-resistant temperature of 300° C. or higher.

### BRIEF DESCRIPTION OF THE DRAWINGS

Features will become apparent to those of ordinary skill in the art by describing in detail exemplary embodiments with reference to the attached drawings, in which:

FIGS. 1 to 4 are cross-sectional views and perspective views schematically illustrating a battery cell according to one or more embodiments of the present disclosure;

FIG. 5 is a view illustrating a battery module according to one or more embodiments of the present disclosure;

FIG. 6A to 6C are views illustrating an example of a jet stream occurring in a battery module according to one or more embodiments of the present disclosure;

FIG. 7 is a schematic block diagram of a battery module design system according to one or more embodiments of the present disclosure;

FIG. 8 is a view schematically illustrating a battery module according to one or more embodiments of the present disclosure;

FIG. 9 is a view schematically illustrating a battery module according to one or more embodiments of the present disclosure;

FIG. 10 is a view schematically illustrating a battery module according to one or more embodiments of the present disclosure;

FIG. 11 is a schematic top view of a battery cell according to one or more embodiments of the present disclosure;

FIG. 12 is a view illustrating a battery pack according to one or more embodiments of the present disclosure;

FIG. 13 is a view illustrating a battery pack according to one or more embodiments of the present disclosure; and

FIG. 14 is a view illustrating a vehicle body and vehicle body parts according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described in detail. However, the embodiments are presented as examples and the present disclosure is only defined by the scope of the claims to be described later.

Unless otherwise specified herein, when a part such as a layer, film, region, plate, etc. is described as being “on” another part, it includes not only the case where the part is “directly on” the other part but also the case where there is still another part therebetween.

Unless otherwise specified in this specification, anything indicated in the singular may also include the plural. Further, unless otherwise stated, “A or B” may mean “including A, including B, or including A and B.”

As used herein, the term “a combination thereof” may mean a mixture, laminate, composite, copolymer, alloy, blend, and reaction product of the components.

Unless otherwise defined in this specification, a particle diameter may be an average particle diameter. Also, the term “particle diameter” refers to the average particle diameter (D50), which means the diameter of particles with a cumulative volume of 50% by volume in the particle size distribution. The average particle diameter (D50) may be measured by methods well known to those of ordinary skill in the art, for example, by a particle diameter analyzer, a transmission electron micrograph, or a scanning electron micrograph. In another method, an average particle diameter D50 value may be obtained by measuring the particle diameter using a measuring device using dynamic light scattering, performing data analysis to count the number of particles for each particle size range, and then calculating the particle diameter therefrom. In other examples, D50 may be measured using laser diffraction. More specifically, when measuring by laser diffraction, after the particles to be measured are dispersed in a dispersion medium, the particles may be introduced into a commercially available laser diffraction particle diameter measuring device (e.g., Microtrac MT 3000) and irradiated with ultrasonic waves of about 28 kHz at an output of 60 W, and the average particle diameter (D50) based on 50% of the particle diameter distribution in the measurement device may be calculated.

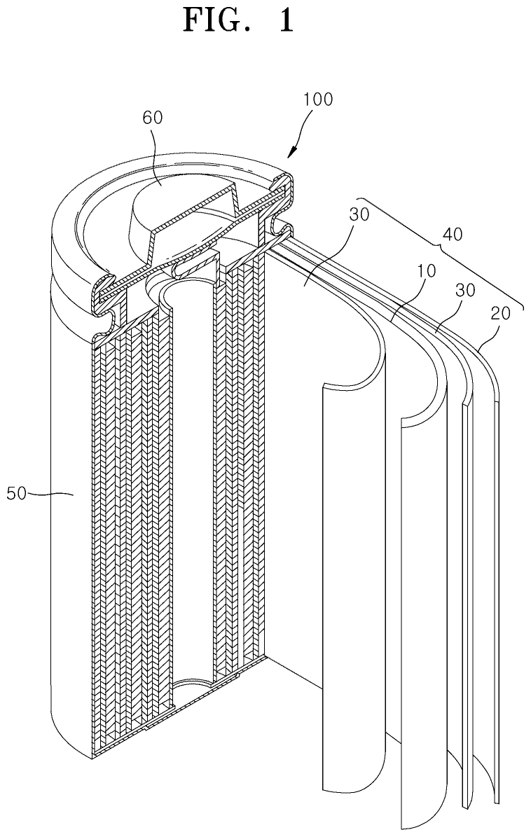

FIGS. 1 to 4 are cross-sectional views schematically illustrating a battery cell according to one or more embodiments of the present disclosure.

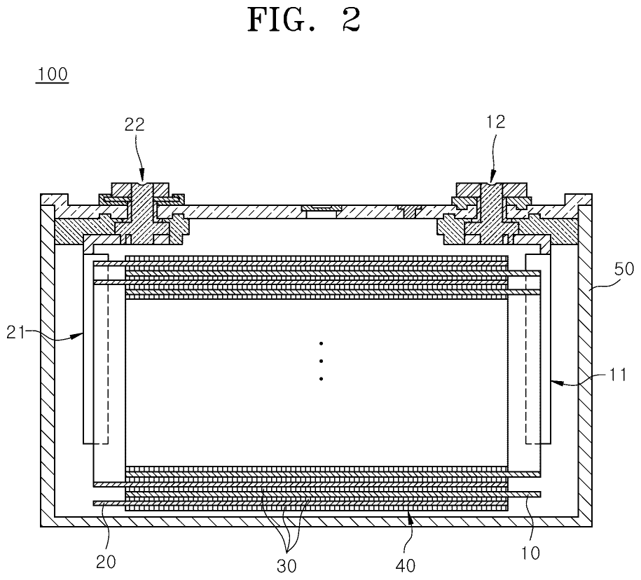

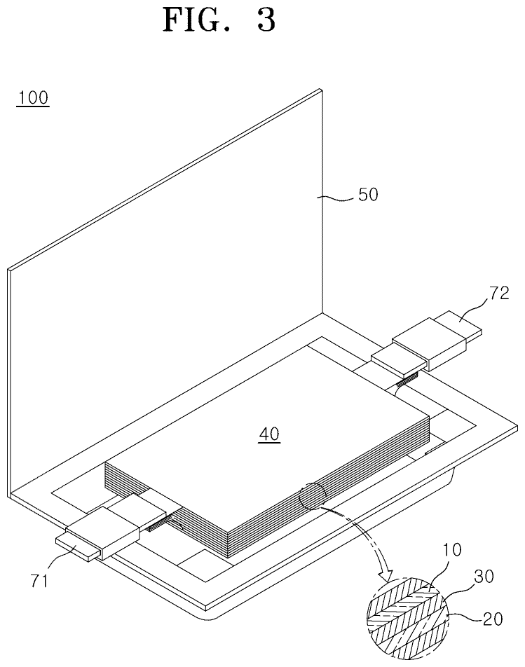

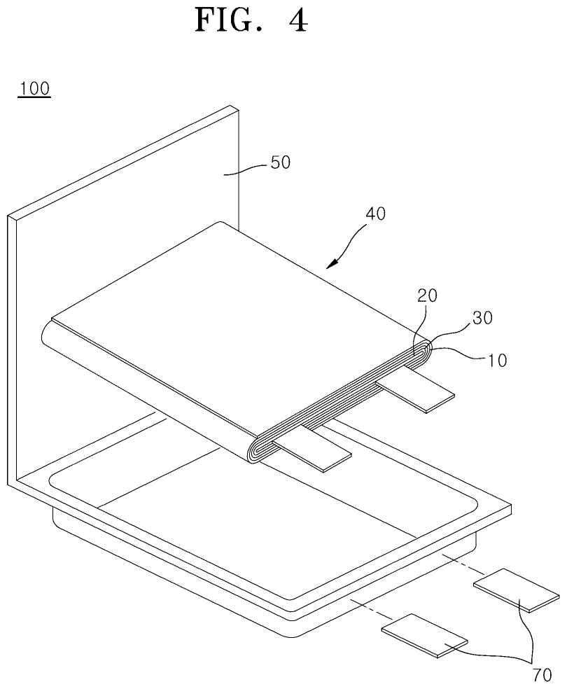

Referring to FIGS. 1 to 4, a battery cell 100 can be classified into cylindrical, prismatic, pouch-shaped, and coin-shaped batteries, etc., depending on its shape. FIGS. 1 to 4 are schematic views illustrating battery cells according to one or more embodiments of the present disclosure, FIG. 1 may be a cylindrical battery, FIG. 2 may be a prismatic battery, and FIGS. 3 and 4 may be a pouch-shaped battery. The battery cell 100 may include an electrode assembly 40 in which a separator 30 is interposed between a positive electrode 10 and a negative electrode 20, and a case 50 into which the electrode assembly 40 is built (e.g., in which the electrode assembly 40 is accommodated). The positive electrode 10, the negative electrode 20 and a separator 30 may include an electrolyte. The battery cell 100 may include a sealing member 60 that seals the case 50 as shown in FIG. 1. In addition, in FIG. 2, the battery cell 100 may include a positive electrode lead tab 11, a positive electrode terminal 12, a negative electrode lead tab 21, and a negative electrode terminal 22. As shown in FIGS. 3 and 4, the battery cell 100 may include an electrode tab 70, i.e., a positive electrode tab 71 and a negative electrode tab 72, which serve as electrical paths for conducting current generated in the electrode assembly 40 to the outside.

As a positive electrode active material, a compound capable of reversible intercalation and deintercalation of lithium (lithiated intercalation compound) may be used. Specifically, at least one composite oxide of lithium and a metal selected from cobalt, manganese, nickel, and a combination thereof may be used.

The composite oxide may be a lithium transition metal composite oxide, and specific examples thereof include lithium nickel oxides, lithium cobalt oxides, lithium manganese oxides, lithium iron phosphate compounds, cobalt-free nickel-manganese oxides, or a combination thereof.

As an example, a compound represented by any one of the following chemical formulas may be used. LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}CO_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{c}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above chemical formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

For example, the positive electrode active material may be a nickel-rich positive electrode active material in which a nickel content is 80 mol % or more, 85 mol % or more, 90 mol % or more, 91 mol % or more, or 94 mol % or more and 99 mol % or less, based on 100 mol % of metal excluding lithium in a lithium transition metal composite oxide. The nickel-rich positive electrode active material can achieve high capacity and thus can be applied to high-capacity, high-density battery cells.

A positive electrode 10 for the battery cell 100 may include a current collector and a positive electrode active material layer formed on the current collector. The positive electrode active material layer includes a positive electrode active material and may further include a binder and/or a conductive material.

For example, the positive electrode may further include an additive that may act as a sacrificial positive electrode.

The content of the positive electrode active material may be 90 wt % to 99.5 wt % based on 100 wt % of the positive electrode active material layer, and the contents of the binder and conductive material may each be 0.5 wt % to 5 wt %, based on 100 wt % of the positive electrode active material layer.

The binder serves to attach the positive electrode active material particles well to each other and also to attach the positive electrode active material well to the current collector. Representative examples of binders include polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, nylon, and the like.

The conductive material is used for imparting conductivity to an electrode, and any material that does not cause chemical change and is electronically conductive may be used in the battery being constructed. Examples of conductive materials include carbon-based materials such as natural graphite, artificial graphite, carbon black, acetylene black, Ketjen black, carbon fibers, carbon nanofibers, and carbon nanotubes; metal-based materials containing copper, nickel, aluminum, and silver in the form of metal powder or metal fibers; conductive polymers such as polyphenylene derivatives; or mixtures thereof.

Al may be used as the current collector, but the present disclosure is not limited thereto.

A negative electrode active material includes a material capable of reversibly intercalating/deintercalating lithium ions, a lithium metal, an alloy of lithium and a metal, a material capable of doping and dedoping lithium, or a transition metal oxide.

The material capable of reversibly intercalating/deintercalating lithium ions may be a carbon-based negative electrode active material, for example, crystalline carbon, amorphous carbon, or a combination thereof. Examples of the crystalline carbon include graphite such as amorphous, platy, flaky, spherical or fibrous natural graphite or artificial graphite, and examples of the amorphous carbon include soft carbon, hard carbon, mesophase pitch carbide, calcined coke, etc.

As the alloy of lithium and a metal, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si negative electrode active material or a Sn negative electrode active material may be used. The Si negative electrode active material may be silicon, a silicon-carbon composite, SiOₓ (0<x<2), a Si—Q alloy (where Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn negative electrode active material may be Sn, SnO₂, a Sn alloy, or a combination thereof.

The silicon-carbon composite may be a composite of silicon and amorphous carbon. According to one or more embodiments, the silicon-carbon composite may be in the form of silicon particles whose surface is coated with amorphous carbon. For example, it may include a secondary particle (core) in which silicon primary particles are assembled and an amorphous carbon coating layer (shell) located on the surface of the secondary particle. The amorphous carbon may also be located between the silicon primary particles, so that, for example, the silicon primary particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles and an amorphous carbon coating layer located on the surface of the core.

The Si negative electrode active material or Sn negative electrode active material may be used in combination with a carbon negative electrode active material.

A negative electrode 20 for the battery cell 100 includes a current collector and a negative electrode active material layer positioned on the current collector. The negative electrode active material layer includes a negative electrode active material and may further include a binder and/or a conductive material.

For example, the negative positive active material layer may include 90 to 99 wt % of the negative positive active material, 0.5 to 5 wt % of the binder, and 0 to 5 wt % of the conductive material.

The binder serves to attach the negative electrode active material particles well to each other and also to attach the negative electrode active material well to the current collector. The binder may be a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluorine rubber, polyethylene oxide, polyvinylpyrrolidone, polyepichlorohydrin, polyphosphazene, poly (meth)acrylonitrile, an ethylene propylene diene copolymer, polyvinylpyridine, chlorosulfonated polyethylene, latex, polyester resin, (meth)acrylic resin, phenol resin, epoxy resin, polyvinyl alcohol, and combinations thereof.

When using an aqueous binder as the negative electrode binder, a cellulose-based compound capable of imparting viscosity may be further included. As the cellulose-based compound, one or more types, such as carboxymethyl cellulose, hydroxypropyl methyl cellulose, methyl cellulose, or alkali metal salts thereof may be used in combination. As the alkali metal, Na, K, or Li may be used.

The dry binder is a polymeric material capable of fiberization and may be, for example, polytetrafluoroethylene, polyvinylidene fluoride, a polyvinylidene fluoride-hexafluoropropylene copolymer, polyethylene oxide, or a combination thereof.

The conductive material is used for imparting conductivity to an electrode, and any material that does not cause chemical change and is electronically conductive may be used in the battery being constructed. Specific examples include carbon-based materials such as natural graphite, artificial graphite, carbon black, acetylene black, Ketjen black, carbon fibers, carbon nanofibers, and carbon nanotubes; metal-based materials containing copper, nickel, aluminum, and silver in the form of metal powder or metal fibers; conductive polymers such as polyphenylene derivatives; or mixtures thereof.

The negative electrode current collector may be selected from copper foil, nickel foil, stainless steel foil, titanium foil, nickel foam, copper foam, a polymer substrate coated with a conductive metal, and a combination thereof.

An electrolyte for the battery cell 100 contains a non-aqueous organic solvent and a lithium salt.

The non-aqueous organic solvent acts as a medium through which ions involved in the electrochemical reaction of the battery can move.

The non-aqueous organic solvent may be a carbonate, ester, ether, ketone, or alcohol solvent, an aprotic solvent, or a combination thereof.

Examples of the carbonate-based solvents may include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), and the like.

Examples of the ester-based solvent may include methyl acetate, ethyl acetate, n-propyl acetate, dimethyl acetate, methyl propionate, ethyl propionate, decanolide, mevalonolactone, valerolactone, caprolactone, and the like.

Examples of the ether-based solvent may include dibutyl ether, tetraglyme, diglyme, dimethoxyethane, 2-methyltetrahydrofuran, 2,5-dimethyltetrahydrofuran, and tetrahydrofuran. In addition, cyclohexanone and the like may be used as the ketone-based solvent. Ethyl alcohol, isopropyl alcohol, and the like may be used as the alcohol-based solvent, and nitriles such as R-CN (where R is a linear, branched, or cyclic hydrocarbon group having 2 to 20 carbon atoms and may include a double bond, an aromatic ring, or an ether group); amides such as dimethylformamide; dioxolanes such as 1,3-dioxolane and 1,4-dioxolane; sulfolane, and the like may be used as the aprotic solvent.

The non-aqueous organic solvent may be used alone or in combination of two or more.

In addition, when using the carbonate solvent, a mixture of a cyclic carbonate and a chain carbonate may be used, and the cyclic carbonate and the chain carbonate may be mixed in a volume ratio of 1:1 to 1:9.

The lithium salt is a material that is dissolved in an organic solvent and acts as a source of lithium ions within the battery, enabling the basic operation of the battery cell and promoting the movement of lithium ions between the positive electrode and negative electrode. Representative examples of lithium salts may include one or two or more selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI), LiC₄FSO₃, LiN (CₓF₂ₓ₊₁SO₂)(C_{y}F_{2y+1}SO₂) (where x and y are integers from 1 to 20), lithium trifluoromethanesulfonate, lithium tetrafluoroethanesulfonate, lithium difluorobis(oxalato)phosphate (LiDFOB), and lithium bis(oxalato)borate (LiBOB).

Depending on the type of battery cell 100, a separator 30 may be present between the positive electrode 10 and the negative electrode 20. As the separator 30, polyethylene, polypropylene, polyvinylidene fluoride, or a multilayer film of two or more layers thereof may be used, and a mixed multilayer film such as a polyethylene/polypropylene two-layer separator, a polyethylene/polypropylene/polyethylene three-layer separator, or a polypropylene/polyethylene/polypropylene three-layer separator may also be used.

The separator 30 may include a porous substrate, and a coating layer including an organic material, an inorganic material, or a combination thereof located on one side or both sides of the porous substrate.

The porous substrate may include at least one polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyether imide, polyamide imide, polybenzimidazole, polyether sulfone, polyphenylene oxide, a cyclic olefin copolymer, polyphenylene sulfide, polyethylene naphthalate, glass fiber, and polytetrafluoroethylene (e.g., Teflon), or a polymer film formed of two or more copolymers or mixtures of these.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the materials may vary.

The organic material and inorganic material may be present in a mixed form in one coating layer or may be present in a form in which a coating layer including the organic material and a coating layer including the inorganic material are laminated.

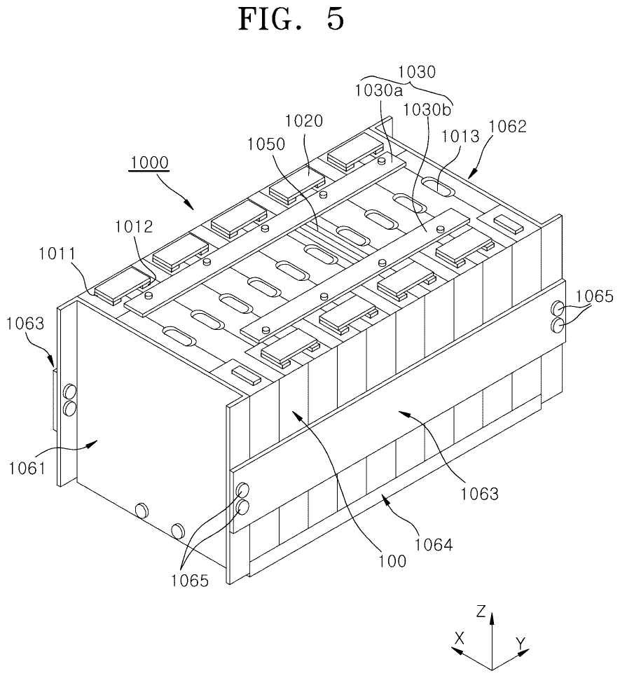

FIG. 5 is a view illustrating a battery module according to one or more embodiments of the present disclosure.

Referring to FIG. 5, a battery module 1000 according to one or more embodiments of the present disclosure includes a plurality of battery cells 100, a housing 1061-1065 in which the plurality of battery cells 100 are accommodated, and a bus bar electrically connecting at least some of the plurality of battery cells 100.

The plurality of battery cells 100 may include, for example, battery cells described in FIGS. 1 to 4, and may be arranged and accommodated in one direction (e.g., the Y-axis direction) within the housing 1061-1065.

The housing 1061-1065 may include a pair of end plates 1061 and 1062 facing the wide surface of the battery cell 100 (e.g., along the X-axis direction), a side plate 1063 connecting the pair of end plates 1061 and 1062, and a bottom plate 1064. The side plate 1063 may support the side surface of the battery cell 100, and the bottom plate 1064 may support the bottom surface of the battery cell 100. In addition, the pair of end plates 1061 and 1062, the side plate 1063, and the bottom plate 1064 may be connected by a member such as a bolt 1065.

The battery module 1000 includes terminal parts 1011 and 1012, a connection tab 1020 connecting adjacent battery cells 100, and a protection circuit module 1030 having one end connected to the connection tab 1020. The protection circuit module 1030 may be a battery management system (BMS). Also, the connection tab 1020 may be a bus bar.

One side of the battery cell 100 may be provided with terminal parts 1011 and 1012 electrically connected to a connection tab 1020 and a vent 1013 which is a passage for discharging gas generated internally. The terminal parts 1011 and 1012 of the battery cell 100 may be a positive electrode terminal part 1011 and a negative electrode terminal part 1012 having different polarities, and the terminal parts 1011 and 1012 of adjacent battery cells 100 may be electrically connected in series or in parallel by a connection tab 1020 to be described below. Meanwhile, although the above description is made by exemplifying a serial connection, various connection structures can be adopted as needed. In addition, the number and arrangement of battery cells may vary from the structure illustrated in FIG. 3 and may be changed as needed.

The protection circuit module 1030 mounts electronic components and protection circuits, and may be electrically connected to a connection tab 1020 to be described below. The protection circuit module 1030 includes a first protection circuit module 1030a and a second protection circuit module 1030b extending at different positions along the direction in which a plurality of battery cells 10 are arranged (e.g., along the Y-axis direction), and at this time, the first protection circuit module 1030a and the second protection circuit module 1030b are spaced apart from each other at a certain interval but positioned parallel to each other so that they may be electrically connected to each adjacent connection tab 1020. For example, the first protection circuit module 1030a is formed to be extended on one upper side of the plurality of battery cells 100 along the direction in which the plurality of battery cells 10 are arranged, and the second protection circuit module 1030b is formed to be extended on the other upper side of the plurality of battery cells 100 along the direction in which the plurality of battery cells 100 are arranged, wherein the second protection circuit module 1030b is spaced apart from the first protection circuit module 1030a at a certain interval with the vent 1013 interposed therebetween, but may be disposed parallel to the first protection circuit module 1030a. In this way, the two protection circuit modules are arranged parallel and spaced apart from each other along the direction in which the plurality of battery cells 100 are arranged, thereby minimizing the area of the printed circuit board (PCB) constituting the protection circuit module 1030. The protection circuit module 1030 is configured separately as two protection circuit modules to minimize unnecessary PCM (Protection Circuit Module) area. Also, the first protection circuit module 1030a and the second protection circuit module 1030b may be connected to each other by a conductive connecting member 1050. At this time, one side of the connecting member 1050 is connected to the first protection circuit module 1030a, and the other side is connected to the second protection circuit module 1030b, so that an electrical connection can be made between the two protection circuit modules.

The connection may be made by any one of soldering, resistance welding, laser welding, and projection welding methods.

Also, the connecting member 1050 may be, for example, an electrical wire. In addition, the connecting member 1050 may be made of a material having elasticity or flexibility. By means of this connecting member 1050, the voltage, temperature, and current of a plurality of battery cells 100 may be checked and managed to ensure they are normal. That is, information such as voltage, current, and temperature received by the first protection circuit module 1030a from its adjacent connection tabs, and information such as voltage, current, and temperature received by the second protection circuit module 1030b from its adjacent connection tabs can be integrated and managed by the protection circuit module through the connecting member 1050.

In addition, when the battery cell 100 swells, the shock can be absorbed by the elasticity or flexibility of the connecting member 1050, thereby preventing the first and second protection circuit modules 1030 from being damaged.

In addition, the shape and structure of the connecting member 1050 may vary from the shape illustrated in FIG. 3.

In this way, since the protection circuit module 1030 is provided as the first and second protection circuit modules 1030a and 1030b, the area of the PCB constituting the protection circuit module may be minimized, thereby securing space inside the battery module. This improves work efficiency by facilitating repairs when an abnormality is detected in the battery module as well as the fastening work of connecting the connection tab 1020 and the protection circuit module 1030.

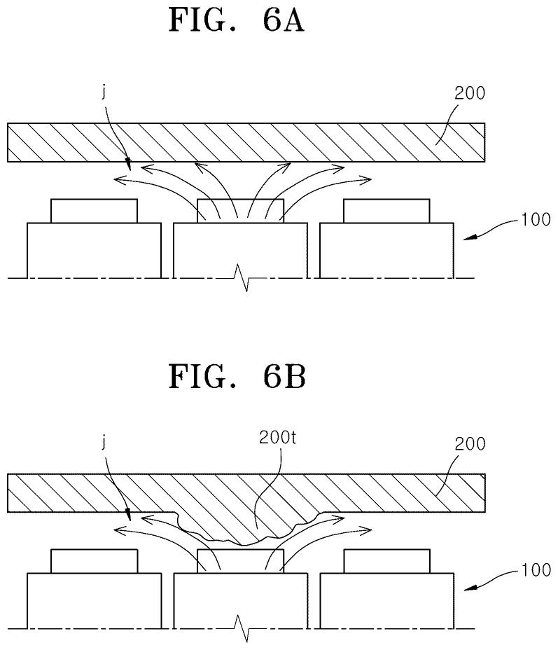

FIG. 6A to 6C are views illustrating an example of a jet stream occurring in a battery module (e.g., the battery module 1000 of FIG. 5).

As described in FIG. 5, the battery module 1000 includes the plurality of battery cells 100 (e.g., including the battery cells 100 described in FIGS. 1 to 4) and a housing 200 that accommodates the plurality of battery cells 100 (e.g., including the housing 1061-1065 described in FIG. 5). At this time, the plurality of battery cells 100 may be arranged in one direction within the housing 200.

Thermal runaway may occur in at least one of the plurality of battery cells 100. For example, the battery cell 100 may repeatedly shrink and expand during the charging and discharging process. In another example, as the battery cell 100 undergoes repeated charge and discharge cycles, the electrode plates (e.g., including the negative electrode plate and the positive electrode plate) included in the battery cell 100 may deteriorate. In still another example, the battery cell 100 may react to internal or external stimuli. During this process, the battery cell 100 may experience a temperature rise and/or thermal runaway.

FIG. 6A shows an example in which thermal runaway occurs in at least one of the plurality of battery cells 100.

In FIG. 6A, j represents heat emitted from the battery cell 100 due to thermal runaway and/or gas generating such heat. As illustrated in FIG. 6A, when thermal runaway occurs in a battery cell 100, the electrode assembly 40 (see FIG. 1) accommodated inside the battery cell 100 may be partially discharged.

FIG. 6B shows an example of the discharged electrode assembly coming into contact with the housing 200.

The electrode assembly discharged from the battery cell 100 and/or the gas (j) emitted from the battery cell 100 may be emitted to the outside of the case 50 (see FIGS. 1 to 4) of the battery cell 100 and may meet the housing 200 located outside the battery cell 100.

At this time, the electrode assembly and/or gas (j) are emitted while accompanying thermal runaway. Accordingly, the electrode assembly and/or gas (j) are formed at a relatively high temperature. On the other hand, the housing 200 is located outside the battery cell 100. Accordingly, the housing 200 is formed at a relatively low temperature.

The electrode assembly and/or gas (j) can rapidly solidify upon contact with the relatively low temperature housing 200. For example, the electrode assembly and/or gas (j) may be formed by solidifying on one side of the housing 200 to form a solidified structure 200t, as shown in FIG. 6B.

FIG. 6C shows an example in which the volume of the solidified structure 200t is increased.

As the processes described in FIGS. 6A and 6B progress, the solidified structure 200t formed on one side of the housing 200 can gradually expand its volume. In this case, the solidified structure 200t can block one side of the battery cell 100. For example, the solidified structure 200t can block a vent that allows heat to escape from the battery cell 100.

Accordingly, the battery module 1000 may not be able to normally discharge heat even when thermal runaway occurs in the battery cell 100. For example, heat generated in the battery cell 100 may not be emitted outside the vent of the battery cell 100 and/or the housing 200 of the battery module 1000. In this case, the battery cell 100 in which thermal runaway has occurred propagates heat (j) toward adjacent battery cells rather than the outside.

Therefore, in order to solve this problem, a method is presented to prevent the vent of the battery cell 100 from being blocked and to prevent heat from propagating to battery cells adjacent to the battery cell 100 in which thermal runaway has occurred.

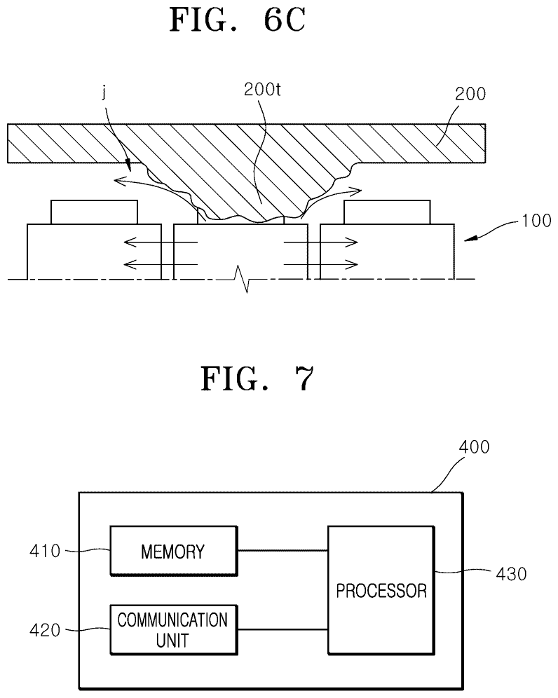

FIG. 7 is a schematic block diagram of a battery module design system according to one or more embodiments of the present disclosure;

In FIG. 7, reference number 400 represents a battery module design system according to one or more embodiments of the present disclosure.

A battery module design system 400 according to one or more embodiments of the present disclosure provides a battery module 1000. The battery module 1000 according to one or more embodiments of the present disclosure, which is designed and provided by the battery module design system 400, can prevent a vent of a battery cell 100 from being blocked even when thermal runaway occurs in a battery cell 100. Furthermore, even when thermal runaway occurs, the battery module 1000 can prevent heat propagation from occurring from a battery cell 100 where thermal runaway has occurred to an adjacent battery cell.

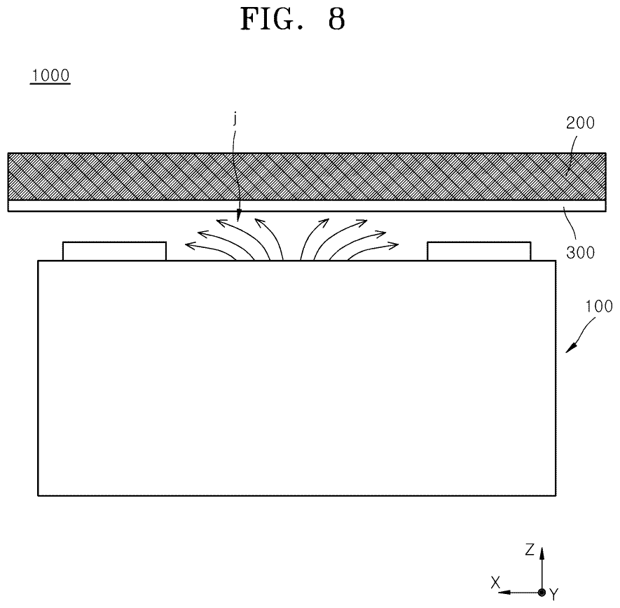

For example, the battery module design system 400 may design and/or provide a battery module 1000 including a plurality of battery cells 100, a housing 200 that accommodates the plurality of battery cells 100, and a protective layer 300 (see FIG. 8) provided on an inner surface of the housing 200 and including a thermal insulation material.

For this purpose, the battery module design system 400 includes a processor 430. The battery module design system 400 may further include a memory 410 and/or a communication unit 420. However, the components of the battery module design system 400 may vary from those illustrated in FIG. 7, and may include all or only some of the components illustrated in FIG. 7. In addition, the battery module design system 400 may further include components other than those shown in FIG. 7. For example, the battery module design system 400 may further include an output part that outputs the result values through visual, auditory, or tactile media. In another example, the battery module design system 400 may further include a contact and/or non-contact input part for receiving commands from a user.

The memory 410 stores data required to operate the battery module design system 400. The data includes, for example, the thermal conductivity of one or more materials included in the protective layer 300. In another example, the data may include the specific heat, density, and the like of one or more materials included in the housing. In still another example, the memory 410 stores commands required to operate the battery module design system 400. The commands may include, for example, a method for providing the most appropriate design for the protective layer 300 to be described below based on the housing 200.

The memory 410 is built into, for example, the battery module design system 400. In another example, the memory 410 may be located outside the battery module design system 400 and communicates with each of components included in the battery module design system 400 through wired or wireless communication. The memory 410 is, for example, a volatile memory or non-volatile memory. The memory 410 includes, for example, a CPU, cache, DRAM, persistent memory, flash SSD, HDD, CD/DVD, cloud server, and the like.

The communication unit 420 enables the battery module design system 400 to transmit and receive data to/from external servers, devices, and the like through wired or wireless communication. In another example, the communication unit 420 enables the battery module design system 400 to communicate with external servers, devices, and the like over short or long distances.

The processor 430 controls all or part of the components included in the battery module design system 400. The processor 430 is built into the battery module design system 400. In another example, the processor 430 may be located outside the battery module design system 400 and control each of components included in the battery module design system 400 through wired or wireless communication.

The processor 430 designs the protective layer 300. For example, the processor 430 retrieves information about the housing 200 and/or the battery cell 100 from the memory 410. In another example, the processor 430 receives information about the housing 200 and/or the battery cell 100 from the communication unit 420. For example, the processor 430 may design the most appropriate protective layer 300 to be applied to the battery module 1000, based on information about the housing 200 to which the protective layer 300 is applied and/or the battery cell 100 built into (e.g., accommodated in) the housing 200. For example, the processor 430 can select a material included in the protective layer 300 and/or determine the thickness of the protective layer 300.

The processor 430 may include, for example, a central processing unit (CPU), a microprocessor unit (MPU), a microcontroller unit (MCU), a graphics processing unit (GPU), a digital signal processor (DSP), a floating-point unit (FPU), an application specific integrated circuit (ASIC), and a field programmable gate array (FPGA).

Through this configuration, the battery module design system 400 can provide a battery module 1000 with improved safety and excellent protection against thermal runaway and/or heat propagation. Hereinafter, a specific method for designing the battery module 1000 by the battery module design system 400 and/or the battery module 1000 provided through the same will be described in detail.

Meanwhile, the battery module 1000 described below includes, for example, a battery module designed by the battery module design system 400.

FIG. 8 is a view schematically illustrating a battery module according to one or more embodiments of the present disclosure.

In FIG. 8, reference number 1000 represents a battery module (e.g., including a battery module described in FIG. 5 or FIG. 7) according to one or more embodiments of the present disclosure.

The battery module 1000 according to one or more embodiments of the present disclosure includes a plurality of battery cells 100; a housing 200; and a protective layer 300.

The plurality of battery cells 100 include, for example, the battery cells 100 described in FIGS. 1 to 4.

The battery cell 100 includes, for example, an electrode assembly; a case in which the electrode assembly is accommodated; and a cap plate coupled to an opening of the case. The description of the electrode assembly is the same as or similar to the description of the electrode assembly 40 of FIGS. 1 to 4. The description of the case is the same as or similar to the description of the case 50 of FIGS. 1 to 4.

The cap plate is coupled to the opening of the case to allow the electrode assembly 40 to be sealed within the case 50. The cap plate is electrically connected to the electrode assembly 40, for example, so that the electrode assembly 40 can be electrically connected to the outside. The description of the cap plate is, for example, the same as or similar to the description of the sealing member 60 described in FIGS. 1 to 4.

At this time, the cap plate may include a vent. For example, when a certain amount of gas is generated from the battery cell 100, the vent provides a path for such gas to be emitted outside the case 50. This allows the vent to prevent the battery cell 100 from exploding due to gas or heat propagating from the battery cell 100 to an adjacent battery cell 100. The vent may be formed in the form of a notch, for example, on at least one side of the cap plate, so as to be easily broken.

The housing 200 accommodates the plurality of battery cells 100. For example, the housing 200 is provided in a direction in which the plurality of battery cells 100 are arranged (see FIG. 5), and includes a pair of end plates facing the wide sides of the battery cells 100. For example, the housing 200 includes the plurality of battery cells 100 arranged between a pair of end plates and a pair of side plates facing the narrow sides of the battery cells 100 (e.g., along the Y-axis direction). For example, the housing 200 includes a lower plate (e.g., bottom plate 1064 in FIG. 5) connected to a pair of end plates and a pair of side plates and provided at lower portions of the plurality of battery cells 100. The housing 200 may further include an upper plate connected to a pair of end plates and a pair of side plates and provided at the upper portions (e.g., along the Z-axis direction in FIG. 5) of the plurality of battery cells 100. The upper plate may be replaced by, for example, a bus bar, a BMS, etc. In FIG. 8, only the upper plate is shown as an example of the housing 200 for convenience of explanation.

A protective layer 300 is provided on the inner surface of the housing 200. The protective layer 300 is provided to face at least one of the plurality of battery cells 100. For example, the protective layer 300 may be provided between the housing 200 and at least one of the plurality of battery cells 100.

At this time, for example, the protective layer 300 may include an adhesive layer to be provided on at least one side of the inner surface of the housing 200. The adhesive layer includes, for example, an acrylic adhesive.

The protective layer 300 can protect the housing 200 from heat generated from the battery cell 100. At this time, the heat generated from the battery cell 100 is formed at a high temperature. Accordingly, the protective layer 300 may include a thermal insulation material.

At this time, the thermal insulation material is, for example, at least one selected from the group consisting of an aerogel, wet silica, dry silica, polyurethane, polystyrene, polyethylene, and polyester, or a mixture of at least two or more thereof. In another example, the thermal insulation material is at least one selected from the group consisting of mica, fiber, mica, talc, diatomaceous earth, bentonite, silicon, feldspar, kaolin, polyimide, and polyethylene terephthalate, or a mixture of at least two or more thereof.

At this time, the battery cell 100 can emit heat to the outside, for example by rupturing the vent. Accordingly, the protective layer 300 may be provided on the inner surface of the housing 200 so as to face the vent. For example, when the vent is located at the upper portion of the battery cell 100, the protective layer 300 may be provided to face toward the upper portion of the battery cell 100. For example, the protective layer 300 may be provided perpendicular to the vent in the height direction (e.g., the protective layer 300 may be spaced apart from and overlap the vent in the Z-axis direction in FIG. 8) of the battery cell 100. Through this, the protective layer 300 can more effectively protect the housing 200 from heat emitted from the battery cell 100.

In this way, the protective layer 300 can protect the housing 200. Through this, the housing 200 can prevent the formation of a solidified structure 200t (see FIG. 6C) or minimize the formation of a solidified structure 200t even when heat is emitted from the battery cell 100. Accordingly, the vent of the battery cell 100 can operate normally during thermal runaway. In addition, the battery cell 100 may not propagate heat toward adjacent battery cells.

The protective layer 300 may be designed to more effectively protect the housing 200. For example, the processor 430 may design a protective layer 300 that satisfies the following Mathematical Formula 1.

$$\frac{1500 - \frac{Tm}{2}}{\frac{1}{h \cdot 0.001 \cdot 2} + \frac{{t}_{i}}{k \cdot 0.001 \cdot 2}} < 0.001 \cdot 2 \cdot \frac{1}{30} \cdot Cp \cdot ρ \cdot {t}_{h} \cdot Tm \qquad [ Mathematical Formula 1 ]$$

In Mathematical Formula 1, Tm represents a melting point of the housing 200 of the battery module 1000. For example, Tm represents a melting point of the material (e.g., cold-rolled carbon steel) or Tm represents the melting point of SPCE (Steel Plate Cold deep drawn Extra).

In Mathematical Formula 1, h represents a convective heat transfer coefficient. For example, h represents a convective heat transfer coefficient of the heat flow emitted from the battery cell 100. In the Mathematical Formula 1, h may have a value of, for example, 10000.

In Mathematical Formula 1, tᵢ represents a thickness of the protective layer 300. The processor 430 designs a thickness of the protective layer 300 so that the protective layer 300 may have tᵢ satisfying Mathematical Formula 1.

In Mathematical Formula 1, k represents a thermal conductivity of the protective layer 300. The processor 430 determines a material having a thermal conductivity satisfying Mathematical Formula 1. The processor 430 designs the protective layer 300 to include such a material.

In Mathematical Formula 1, Cp represents a specific heat of the housing 200. For example, Cp represents a specific heat of the material in the area where the protective layer 300 is provided in the housing 200. For example, when a protective layer 300 is provided on the upper plate in the housing 200, Cp represents a specific heat of the material included in the upper plate.

In Mathematical Formula 1, ρ represents a density of the housing 200. For example, ρ represents a density of the material in the area where the protective layer 300 is provided in the housing 200. For example, when a protective layer 300 is provided on the upper plate in the housing 200, ρ represents a density of the material included in the upper plate.

In Mathematical Formula 1, tₕ represents a thickness of the housing 200.

That is, through Mathematical Formula 1, the processor 430 can design the conditions of the most appropriate protective layer 300 to protect the housing 200 based on information about the battery cell 100 and/or the housing 200. Accordingly, the protective layer 300 may be formed to have a thickness and/or thermal conductivity satisfying Mathematical Formula 1.

In addition, the processor 430 can select the material of the housing 200 through Mathematical Formula 1.

Through this configuration, the battery module design system 400 according to one or more embodiments of the present disclosure can design a battery module 1000 with improved safety. In addition, the battery module 1000 according to one or more embodiments of the present disclosure prevents heat propagation even in the event of thermal runaway, thereby enhancing safety.

Hereinafter, various embodiments of such battery modules 1000 will be described.

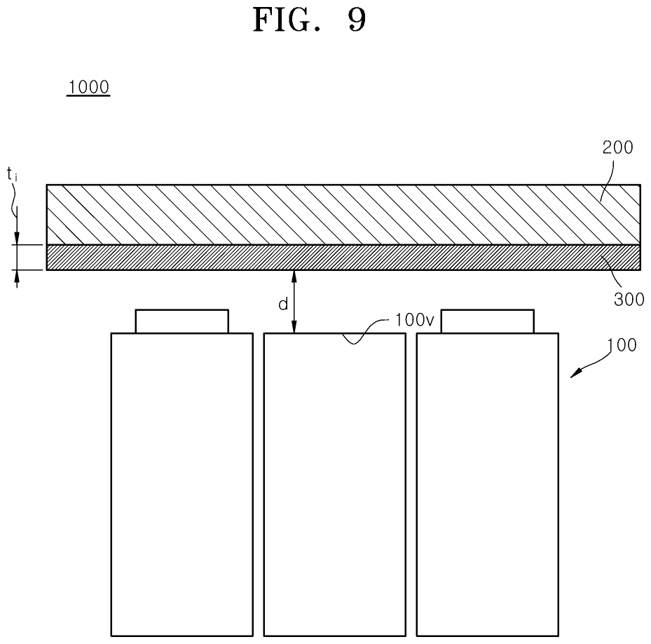

FIG. 9 is a view schematically illustrating a battery module according to one or more embodiments of the present disclosure.

In FIG. 9, reference number 1000 represents a battery module (e.g., including a battery module 1000 described in FIG. 5, FIG. 7, and FIG. 8) according to one or more embodiments of the present disclosure.

The battery cell 100 includes a cap plate. The cap plate may include a vent to allow heat to be emitted from the battery cell 100. For example, the cap plate is provided on the upper portion of the case of the battery cell 100. That is, the vent 100v may be provided at the upper portion of the battery cell 100.

The protective layer 300 is provided to face the cap plate of the battery cell 100. The protective layer 300 is provided to face the vent 100v formed in the battery cell 100. When the vent 100v is formed at the upper portion of the battery cell 100, the protective layer 300 is provided above the upper portions of the plurality of battery cells 100. That is, the protective layer 300 may be formed on the lower portion of the upper surface plate and toward the upper portion of the battery cell 100, thereby opposing the vent 100V.

The protective layer 300 may be formed to have a predetermined thickness (tᵢ) range. For example, the protective layer 300 may be formed to have a thickness of 5.0 mm or less. In another example, the protective layer 300 may be formed to have a thickness of 4.5 mm or less. In still another example, the protective layer 300 may be formed to have a thickness of 4.0 mm or less. In yet another example, the protective layer 300 may be formed to have a thickness of 3.5 mm or less. In another example, the protective layer 300 may be formed to have a thickness of 3.0 mm or less. In still other examples, the protective layer 300 may be formed to have a thickness of 2.9 mm or less, 2.8 mm or less, 2.7 mm or less, 2.6 mm or less, or 2.5 mm or less. When the thickness of the protective layer 300 is out of this range, the capacity of the battery cell 100 may decrease as the thickness of the protective layer 300 becomes too thick. Therefore, it is preferable that the thickness range of the protective layer 300 satisfies the above-mentioned range. In addition, the protective layer 300 may simultaneously satisfy the thickness range satisfying Mathematical Formula 1 described with respect to FIG. 8.

That is, the protective layer 300 may be formed to have a thickness of 5.0 mm or less while satisfying, for example, Mathematical Formula 1. In another example, the protective layer 300 may be formed to have a thickness of 3.0 mm or less while satisfying Mathematical Formula 1. Through this, the protective layer 300 may be formed to have a thickness that is adequate to protect the housing 200 while not degrading the capacity of the battery module 1000.

The protective layer 300 may include a material having a heat-resistant temperature of 200° C. or higher, 220° C. or higher, 240° C. or higher, 260° C. or higher, 280° C. or higher, or 300° C. or higher. Through this, the protective layer 300 can protect the housing 200 from heat emitted from the battery cell 100.

The protective layer 300 may be formed, for example, at a predetermined distance (d) from the battery cell 100. At this time, the predetermined distance (d) represents the shortest distance between the battery cell 100 and the protective layer 300. For example, the predetermined distance (d) represents the shortest distance between the vent 100v and the protective layer 300. For example, the protective layer 300 may be formed at a distance of 30 mm or less from the battery cell 100. This allows the protective layer 300 to meet the heat emitted from the battery cell 100 via convection. Accordingly, the protective layer 300 prevents the housing 200 from being damaged by the heat emitted from the battery cell 100.

Through this configuration, the protective layer 300 can effectively protect the housing 200 and improve the safety of the battery module 1000.

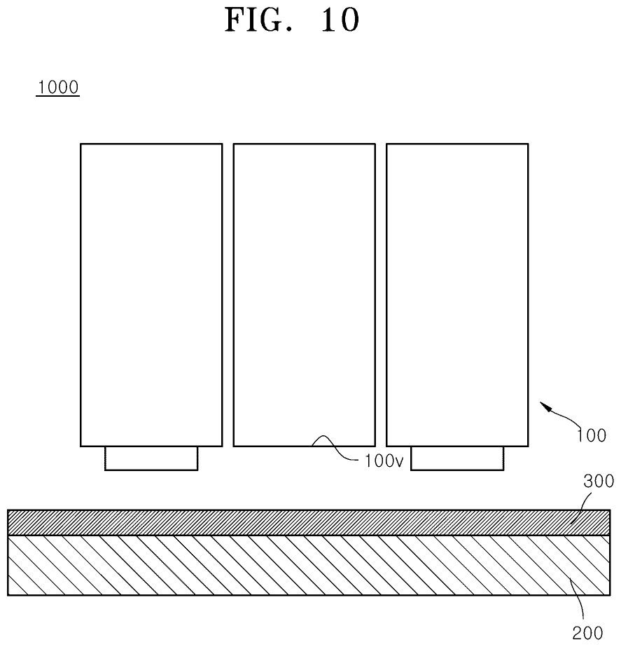

FIG. 10 is a view schematically illustrating a battery module according to one or more embodiments of the present disclosure.

In FIG. 10, 1000 represents a battery module (e.g., including a battery module 1000 described in FIG. 5, FIG. 7, and FIG. 8) according to one or more embodiments of the present disclosure.

FIG. 10 shows an example in which a battery cell 100 includes a cap plate. At this time, the cap plate is provided on the lower portion of the battery cell 100 (in the configuration shown). For example, a cap plate is formed at the lower portion of the case while sealing the case that forms an opening toward the lower portion of the battery cell 100. The cap plate may form (e.g., include) a vent to allow heat to be emitted from the battery cell 100. That is, the vent 100v may be provided at the lower portion of the battery cell 100.

The protective layer 300 is provided to face the cap plate of the battery cell 100 (e.g., the protective layer 300 may extend continuously to face the cap plate of a plurality of battery cells 100). The protective layer 300 is provided to face the vent 100v formed in the battery cell 100. When the vent 100v is formed at the lower portion of the battery cell 100, the protective layer 300 is provided below the lower portions of the plurality of battery cells 100. That is, the protective layer 300 may be formed on the upper portion of the lower surface plate and toward the lower portion of the battery cell 100, thereby opposing the vent 100V.

The thickness, thermal conductivity, position, and/or distance from the battery cell 100 of protective layer 300 are the same as or similar to those described in FIG. 9.

Through this configuration, the protective layer 300 can effectively protect the housing 200 and improve the safety of the battery module 1000.

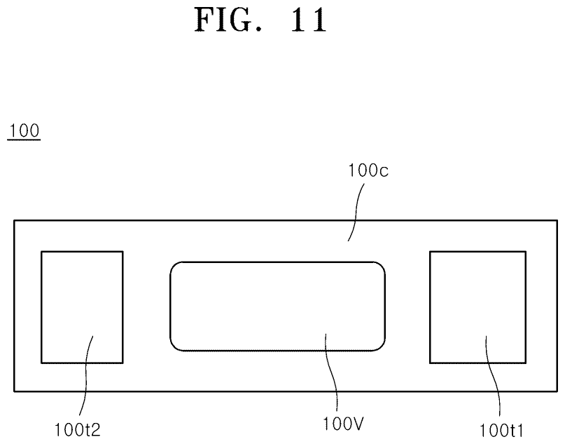

FIG. 11 is a schematic top view of a battery cell according to one or more embodiments of the present disclosure.

In FIG. 11, reference number 100 represents a battery cell (e.g., including a battery cell 100 described in FIGS. 1 to 5 and FIGS. 7 to 10) according to one or more embodiments of the present disclosure.

In FIG. 11, for convenience of explanation, only the cap plate 100c included in the battery cell 100 is shown. Meanwhile, the cap plate 100c shown in FIG. 11 is shown as a shape applicable to a prismatic battery cell, but the cap plate described through one or more embodiments of the present disclosure can be applied to battery cells of all shapes. For example, a cap plate is applied to a cylindrical battery cell and may include a cap up, a vent part, an insulator and/or a cap down. In this way, the vent part may be formed integrally with a single cap plate or may be formed as a part of the cap assembly.

The cap plate 100c may have a vent 100v formed in a part thereof. In addition, the cap plate 100c may include a first terminal 100t1 connected to the first electrode and/or a second terminal 100t2 connected to the second electrode. At this time, the first electrode includes, for example, a positive electrode 10 or a negative electrode 20 described in FIGS. 1 to 4, and the second electrode includes, for example, the other of a negative electrode 20 or a positive electrode 10 described in FIGS. 1 to 4.

As described above, in the height direction of the battery cell 100 (e.g., the Z-axis direction in FIG. 5), the protective layer 300 is formed perpendicular to the vent 100v. Accordingly, the protective layer 300 may be positioned to face the vent 100v through the shortest distance.

When viewed from above, the protective layer 300 is formed to have an area of 50% or more of the area of the vent 100v, 70% or more of the area of the vent 100v, 100% or more of the area of the vent 100v, 110% or more of the area of the vent 100v, 120% or more of the area of the vent 100v, 130% or more of the area of the vent 100v, 140% or more of the area of the vent 100v, or 150% or more of the area of the vent 100v. That is, the cross-sectional area of the protective layer 300 may be formed to have an area of 50% or more of the cross-sectional area of the vent 100v. Through this, the protective layer 300 can effectively protect the housing 200 from heat emitted through the vent 100v.

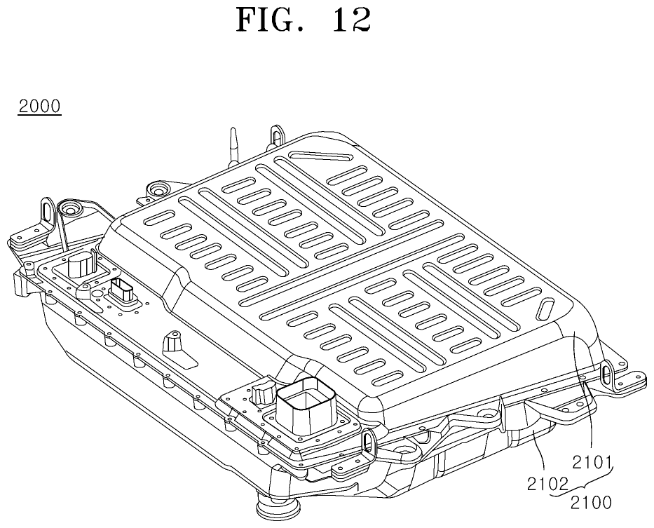

FIG. 12 is a view illustrating a battery pack according to one or more embodiments of the present disclosure.

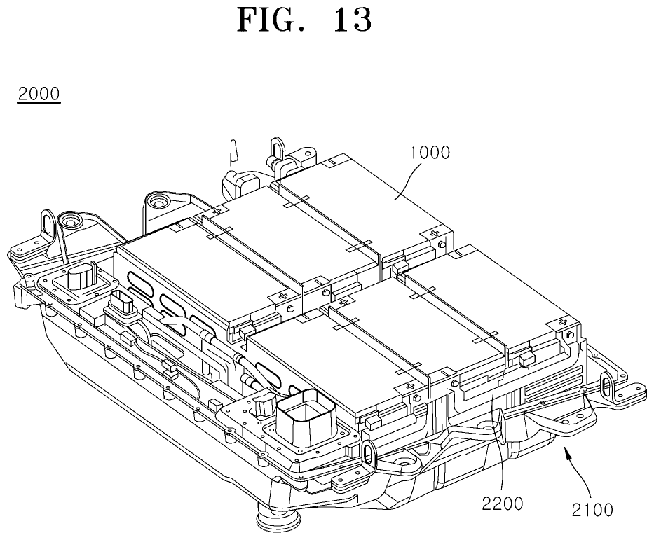

FIG. 13 is a view (e.g., a view of the battery pack of FIG. 12 without the cover) illustrating a battery pack according to one or more embodiments of the present disclosure.

A battery pack 2000 according to an embodiment of the present disclosure includes an assembly of electrically connected individual batteries and a pack case accommodating the assembly. In the drawing, for the convenience of illustration, parts such as bus bars, cooling units, and external terminal parts for electrical connection of batteries are omitted.

Specifically, the battery pack 2000 may include a plurality of battery modules 1000 (e.g., including the battery modules 1000 described in FIG. 10) and a pack case 2100 for accommodating the battery modules 1000. For example, the pack case 2100 may include first and second pack cases 2101 and 2102 that are coupled to face each other after a plurality of battery modules 1000 are interposed therebetween. The plurality of battery modules 1000 may be electrically connected to each other using a bus bar 2200, and the plurality of battery modules 1000 may be electrically connected to each other in a series, parallel or series-parallel hybrid manner to obtain a required electrical output.

Meanwhile, the protective layer 300 described in FIGS. 7 to 11 may be applied equally or similarly to the battery pack 2000. For example, the protective layer 300 may be provided on the inner surface of the pack case 2100 at a position facing the battery module 1000 and/or the battery cell 100. Through this, the protective layer 300 can help improve the safety of the battery pack 2000 even when thermal runaway occurs inside the battery pack 2000.

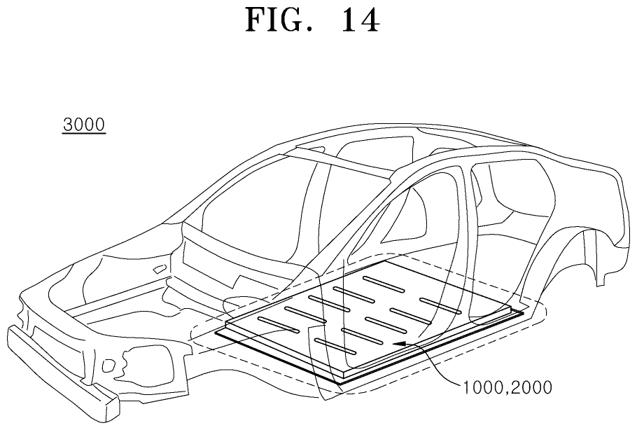

FIG. 14 shows a view illustrating a vehicle body and vehicle body parts according to one or more embodiments of the present disclosure.

A battery module 1000 according to one or more embodiments of the present disclosure described in FIGS. 5 to 11 and/or a battery pack 2000 according to one or more embodiments of the present disclosure described in FIGS. 12 and 13 may be mounted in a vehicle 3000. The vehicle 3000 may be, for example, an electric vehicle, a hybrid vehicle or a plug-in hybrid vehicle. The vehicle includes a four-wheeled vehicle or a two-wheeled vehicle.

As illustrated in FIG. 14, the vehicle 3000 according to one or more embodiments of the present disclosure includes the battery module 1000 and/or the battery pack 2000 including the battery module 1000 according to one or more embodiments of the present disclosure. The vehicle 3000 operates by receiving power from the battery module 1000 and/or the battery pack 2000 including the battery module 1000 according to one or more embodiments of the present disclosure.

The methods, processes, and/or operations described herein may be performed by code or instructions to be executed by a computer, processor, controller, or other signal processing device. The computer, processor, controller, or other signal processing device may be those described herein or one in addition to the elements described herein. The algorithms, code or instructions for implementing the operations of the method embodiments herein may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, or controller which is to execute the code or instructions for performing the method embodiments described herein.

According to the present disclosure, a battery module with improved safety can be provided.

According to the present disclosure, a battery module design system capable of providing a battery module with improved safety can be provided.

However, the effects obtainable through the present disclosure are not limited to the effects described above, and other technical effects not mentioned will be clearly understood by those skilled in the art from the description of the disclosure described below.

Although the present disclosure has been described above by means of limited embodiments and drawings, the present disclosure is not limited thereto, and various modifications and variations can be made by those skilled in the art to which the present disclosure pertains within the scope of the technical idea of the present disclosure and the equivalent scope of the claims to be described below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of battery cells;
a housing accommodating the plurality of battery cells; and
a protective layer on an inner surface of the housing to face the plurality of battery cells, the protective layer including a thermal insulation material.

2. The battery module as claimed in claim 1, wherein each of the plurality of battery cells includes:
an electrode assembly;
a case accommodating the electrode assembly; and
a cap plate including a vent, the cap plate being coupled to an opening of the case, wherein the protective layer faces the vent.

3. The battery module as claimed in claim 2, wherein the protective layer of each of the plurality of battery cells is perpendicular to the vent in a height direction.

4. The battery module as claimed in claim 2, wherein the protective layer of each of the plurality of battery cells has an area of 50% or more of an area of the vent when viewed from above the vent.

5. The battery module as claimed in claim 2, wherein:
the cap plate is at a lower portion of the case, and
the protective layer is on lower portions of the plurality of battery cells.

6. The battery module as claimed in claim 2, wherein:
the cap plate is at an upper portion of the case, and
the protective layer is above upper portions of the plurality of battery cells.

7. The battery module as claimed in claim 1, wherein the protective layer has a thickness and thermal conductivity satisfying Mathematical Formula 1:
$$\frac{1500 - \frac{Tm}{2}}{\frac{1}{h \cdot 0.001 \cdot 2} + \frac{{t}_{i}}{k \cdot 0.001 \cdot 2}} < 0.001 \cdot 2 \cdot \frac{1}{30} \cdot Cp \cdot ρ \cdot {t}_{h} \cdot Tm$$
wherein Tm represents a melting point of the housing, h represents a convective heat transfer coefficient, tᵢ represents a thickness of the protective layer, k represents a thermal conductivity of the protective layer, Cp represents a specific heat of the housing, ρ represents a density of the housing, and tₕ represents a thickness of the housing.

8. The battery module as claimed in claim 1, wherein the protective layer has a thickness of 3 mm or less.

9. The battery module as claimed in claim 1, wherein the protective layer has a heat-resistant temperature of 300° C. or higher.

10. The battery module as claimed in claim 1, wherein the protective layer is at a distance of 30 mm or less from the plurality of battery cells.

11. A battery module design system, comprising:
a processor for designing a battery module,
wherein the processor is configured to design the battery module to include a plurality of battery cells, a housing in which the plurality of battery cells are accommodated and a protective layer positioned between the housing and at least one of the plurality of battery cells and including a thermal insulation material, and
wherein the processor is further configured to design the protective layer.

12. The battery module design system as claimed in claim 11, wherein each of the plurality of battery cells includes:
an electrode assembly;
a case accommodating the electrode assembly; and
a cap plate including a vent, the cap plate being coupled to an opening of the case, wherein the processor is configured to design the protective layer to face the vent.

13. The battery module design system as claimed in claim 11, wherein the processor is configured to design the protective layer to have a thickness and thermal conductivity satisfying Mathematical Formula 1:
$$\frac{1500 - \frac{Tm}{2}}{\frac{1}{h \cdot 0.001 \cdot 2} + \frac{{t}_{i}}{k \cdot 0.001 \cdot 2}} < 0.001 \cdot 2 \cdot \frac{1}{30} \cdot Cp \cdot ρ \cdot {t}_{h} \cdot Tm$$
wherein Tm represents a melting point of the housing, h represents a convective heat transfer coefficient, tᵢ represents a thickness of the protective layer, k represents a thermal conductivity of the protective layer, Cp represents a specific heat of the housing, ρ represents a density of the housing, and tₕ represents a thickness of the housing.

14. The battery module design system as claimed in claim 13, wherein the processor is configured to design the protective layer to have a thickness of 3 mm or less while satisfying Mathematical Formula 1.

15. The battery module design system as claimed in claim 13, wherein the processor is configured to design the protective layer with a heat-resistant temperature of 300° C. or higher.
